(19) United States
(12) Patent Application Publication
(10) Pub. No.: US 2017/0175986 A1
(43) Pub. Date: Jun. 22, 2017

(54) LED COLOR ORGAN PICKGUARD

(71) Applicant: WIL-CHEN-ZQUI DESIGN, LLC, San Mateo, CA (US)

(72) Inventor: Paul A. Wilczynski, Vallejo, CA (US)

(73) Assignee: WIL-CHEN-ZQUI DESIGN, LLC, San Mateo, CA (US)

(21) Appl. No.: 15/367,006

(22) Filed: Dec. 1, 2016

Related U.S. Application Data
(60) Provisional application No. 62/261,712, filed on Dec. 1, 2015.

(51) Int. Cl. F21V 23/00; G10D 3/00; A63J 17/00; H05B 37/02

(52) U.S. Cl. CPC F21V 23/005; H05B 37/0227; G10D 3/00; A63J 17/00; G10H 2220/005; G10H 2220/461; G10H 2220/061; G10H 1/368

(57) ABSTRACT

A pickguard having a color organ circuit integrated with the pickguard.

### CROSS-REFERENCE

This patent application claims priority from U.S. Provisional Patent Application No. 62/261,712 entitled Color Organ Instrument Pickguard, filed Dec. 1, 2015.

### TECHNICAL FIELD

This disclosure relates to a pickguard for a stringed musical instrument, and more particularly, to a pickguard having an integrated color organ.

### BACKGROUND

Some stringed musical instruments, like guitars and the mandolin, are often played using a pick. Therefore, it is common for such instruments to include a pickguard to protect the instrument finish from scratching by the pick.

In addition, the pickguard may be used to provide a decorative aspect to the instrument by adding a color, design or other interesting feature that complements the visual appearance of the instrument. For example, the pickguard on the iconic Gibson® Hummingbird guitar includes a design showing a hummingbird and flowers.

In the early 1970s, Rickenbacker incorporated a color organ circuit into the body of an electrical guitar, visible through a translucent or transparent cover, and sold as the model 331 “Lightshow” guitar. For example, the color organ circuit was configured to drive red lamps for higher frequency notes, yellow (or green) lamps for middle frequency notes, and blue for lower frequency notes. However, the technology used in the Lightshow guitar is archaic by today's standards, for example, the lamps were 12V automobile tail light bulbs.

Therefore, it would be desirable to find new and efficient ways to incorporate a color organ into a stringed musical instrument.

### BRIEF DESCRIPTION OF DRAWINGS

FIG. 1 is a plan view illustrating a typical cross-section of a pickguard having an integrated color organ in accord with the present disclosure.

FIG. 2A is a front perspective view of one embodiment of a pickguard with a color organ circuit visible under the pickguard.

FIG. 2B is a front plan view of the pickguard shown in FIG. 2A.

FIG. 3A is a first portion of the pickguard shown in FIG. 2B illustrating a first portion of the color organ circuit.

FIG. 3B is a second portion of the pickguard shown in FIG. 2B illustrating a second portion of the color organ circuit.

FIG. 3C is a third portion of the pickguard shown in FIG. 2B illustrating a third portion of the color organ circuit.

FIG. 3D is a fourth portion of the pickguard shown in FIG. 2B illustrating a fourth portion of the color organ circuit.

FIG. 4 is a schematic diagram illustrating one embodiment of the color organ circuit.

FIG. 5A is a first portion of the color organ circuit shown in FIG. 4.

FIG. 5B is a second portion of the color organ circuit shown in FIG. 4.

FIG. 5C is a third portion of the color organ circuit shown in FIG. 4.

FIG. 5D is a fourth portion of the color organ circuit shown in FIG. 4.

FIG. 5E is a fifth portion of the color organ circuit shown in FIG. 4.

FIG. 5F is a sixth portion of the color organ circuit shown in FIG. 4.

FIG. 5G is a seventh portion of the color organ circuit shown in FIG. 4.

### DETAILED DESCRIPTION

1. Overview

This disclosure is directed to an actively decorative pickguard for a stringed musical instrument, such as guitar, mandolin, etc. The pickguard is actively decorative by having a color organ circuit integrated with the pickguard. When the instrument is played, the color organ circuit drives light emitting diodes (“LEDs”) that have been organized to display different colors that relate to the pitch (frequency) and/or loudness (amplitude) of the notes that are played on the instrument.

In addition to the active decoration feature of the color organ circuit, the pickguard provides the same functional and decorative benefits of existing pick guards—it protects the instrument from scratches caused by picks or fingernails when the instrument is played, and it provides a decorative shape and color element on the face of the instrument even when the color organ circuit is not active.

The pickguard can be installed by an Original Equipment Manufacturer during original construction of the instrument, or it can be installed by an end-user subsequent to purchase of the instrument, either as a pick guard overlay, a pick guard replacement, or as an added pick guard if none existed previously.

2. Pickguard Construction

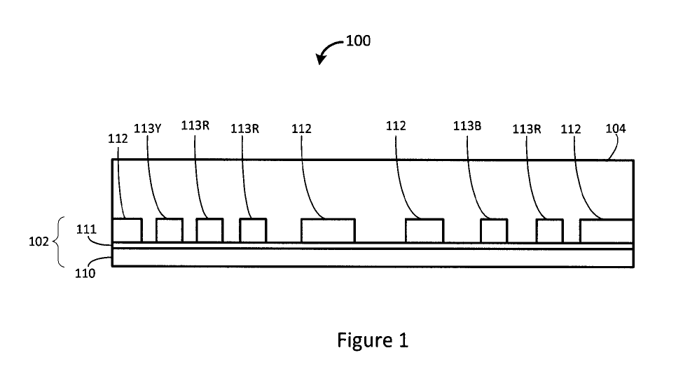

FIG. 1 illustrates a schematic cross-sectional representation of a pickguard having an integrated color organ. The pickguard is a thin hybrid laminated plastic overlay 100, e.g., 0.090 inches to 0.125 inches thick, which is attached to the instrument (not shown). The laminate overlay 100 includes a lower layer 102 and an upper layer 104 formed over the lower layer. The lower layer 102 includes an epoxy printed circuit board 110 having printed circuit traces 111 formed on the board and electronic circuit components mounted to the board and its circuit traces. The electronic circuit components are preferably solid state surface-mount devices (SMDs) 112, 113 because of their small size and thickness, rather than through-hole devices, in order to provide a thinner profile for the pickguard. The SMDs include different colored surface-mount LEDs, such as LED 113Y for yellow, LEDs 113R for red, and LED 113B for blue.

The upper layer 104 is a protective layer that is formed, e.g., cold-poured or hot injection molded, over the circuit board 110, circuit traces 111, and SMDs 112, 113 to provide a water-clear transparent surface, or it may be frosted and/or colored translucent plastic. For example, an optically transparent urethane may be cold poured over the circuit board 110, circuit traces 111, and SMDs 112, 113, leveled off and cured at room temperature.

The functions of the upper layer 104 of the plastic lamination are: (i) to protect the circuit board and its components; (ii) to add stiffness and thickness to the product; and (iii) to provide a glossy top surface to resist wear of the guitar body itself.

This top lamination may be water-clear transparent to allow the circuit and electronic components to show through as a decorative element, or it can be frosted, patterned or tinted in order to obscure the circuit and components, allowing only the lights to show through. Additionally, the surface of the color organ pickguard can be decorated by silk-screening, or tampo printing, or dye-sublimation printing.

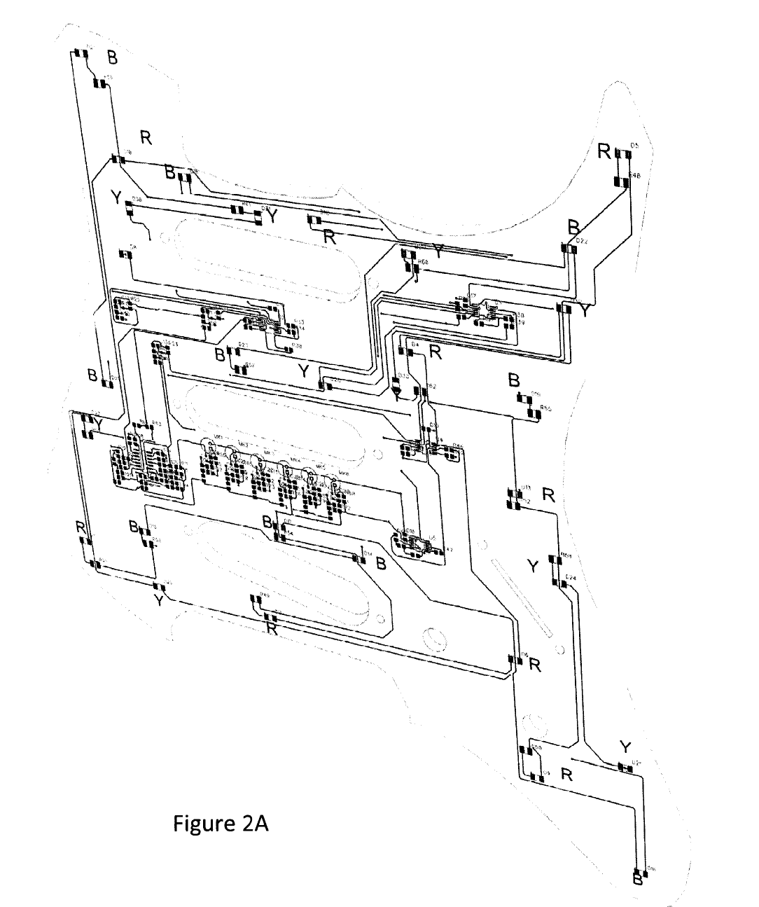

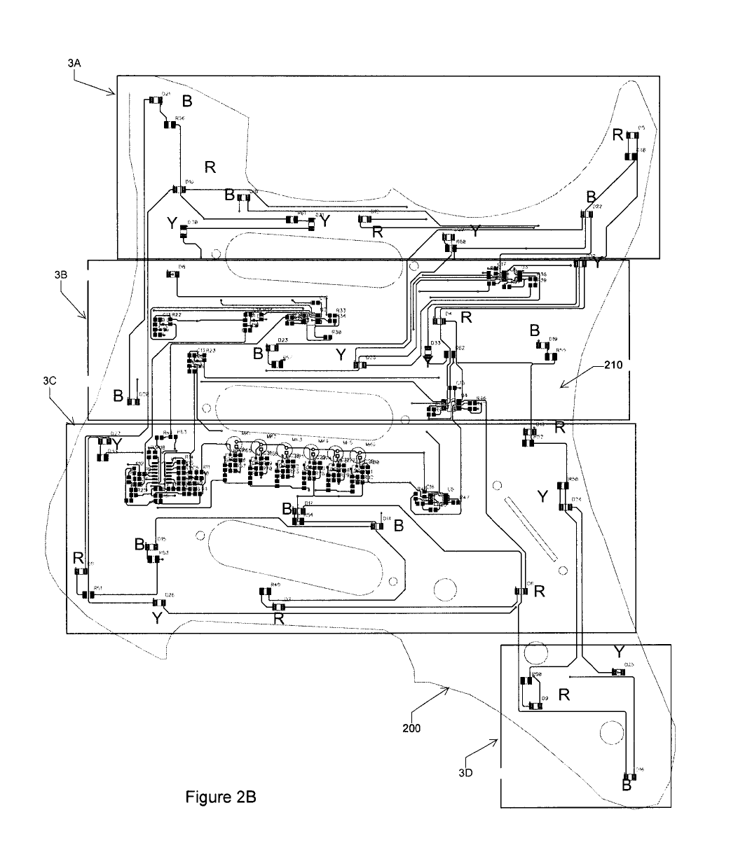

The plastic overlay 100 can be configured to have any desirable shape. For example, the overlay 100 could be formed to match the shape of the OEM pickguard on a guitar or other instrument, as further illustrated in FIGS. 2A-2B.

3. Electronics

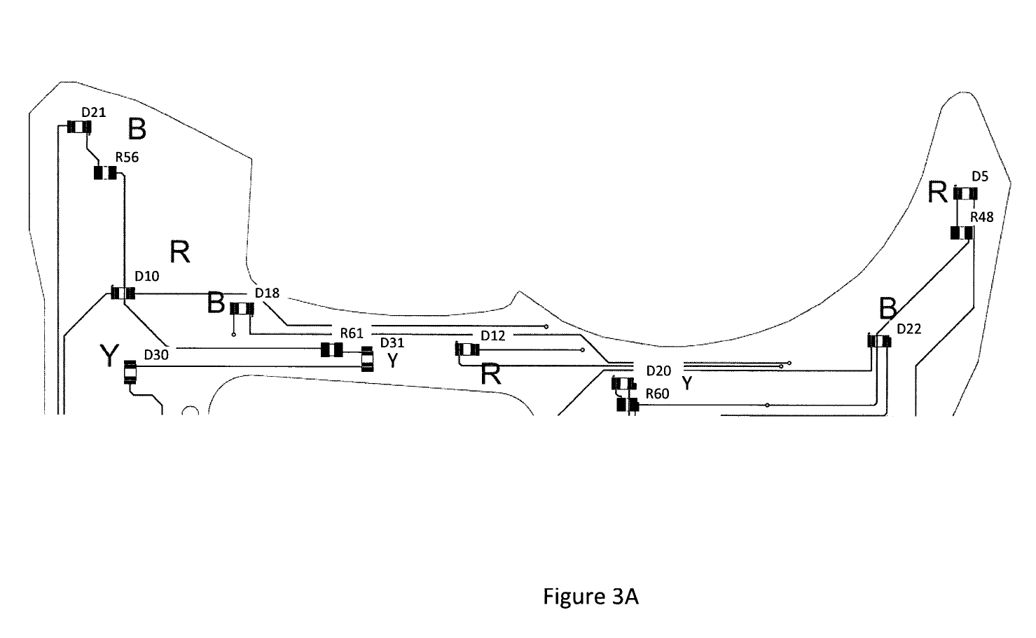

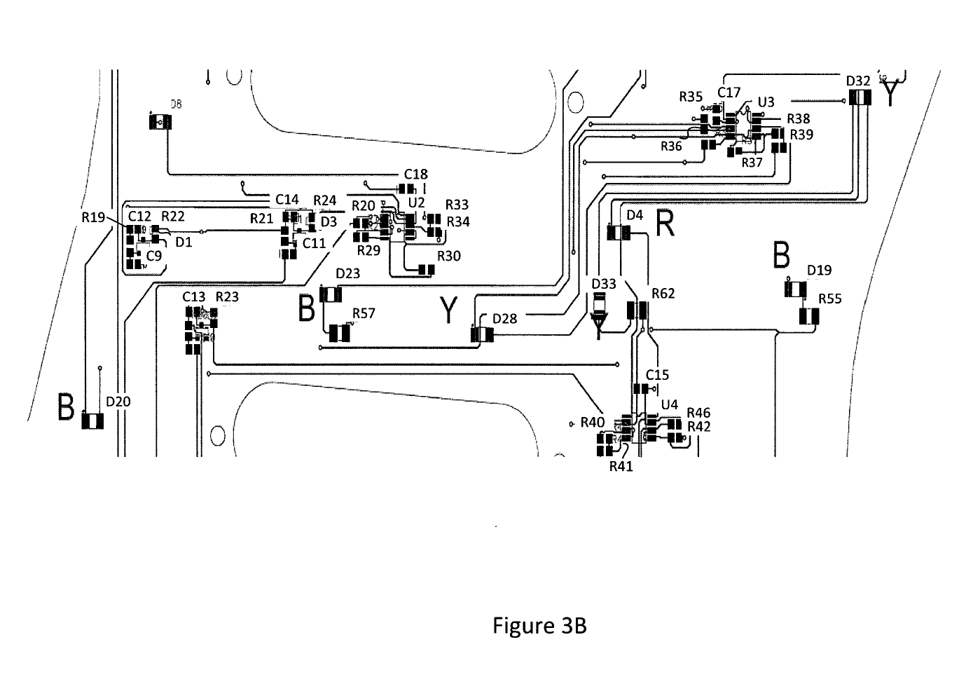

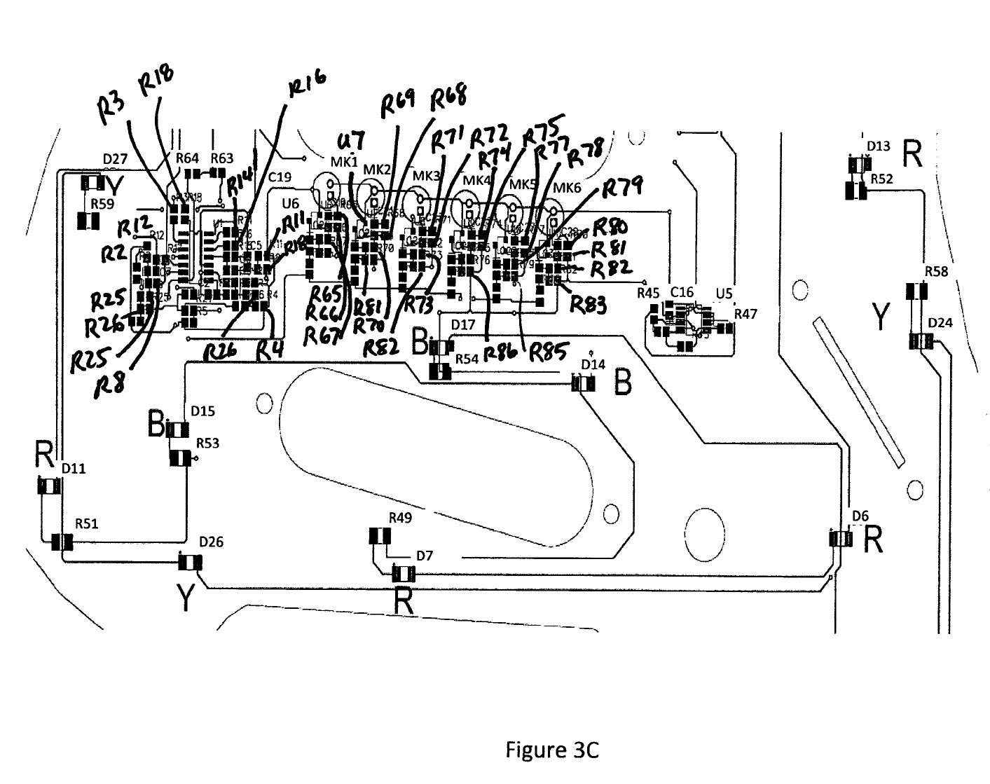

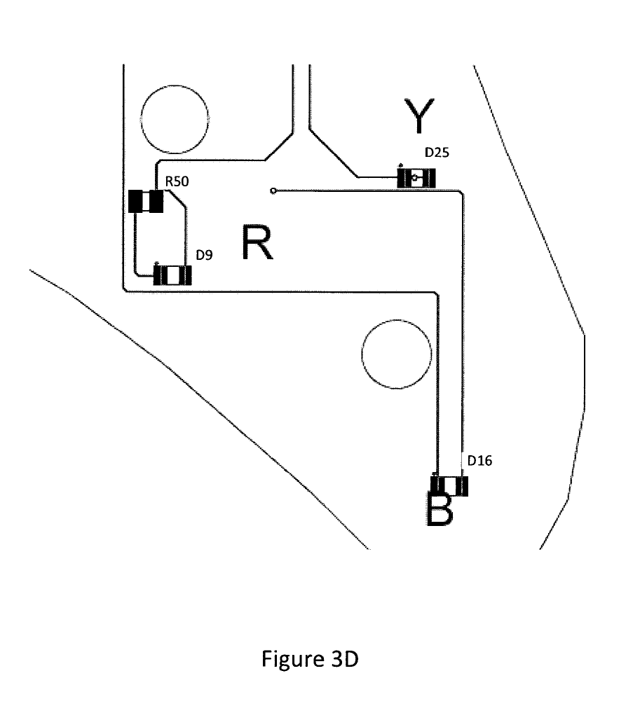

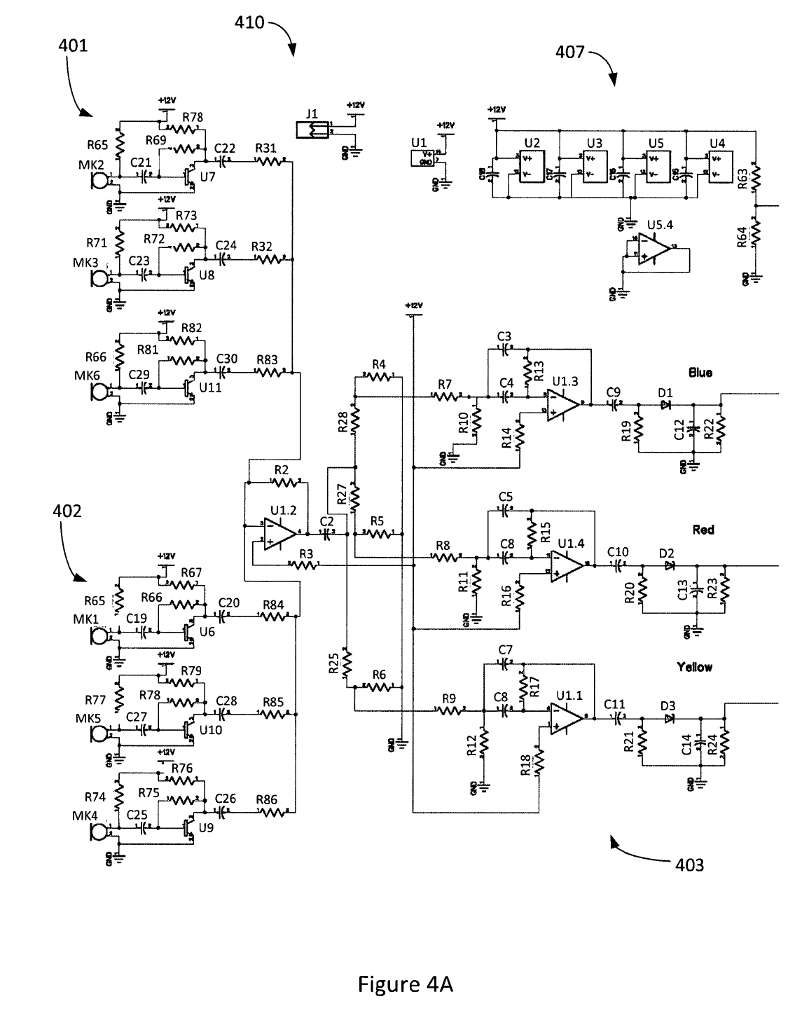

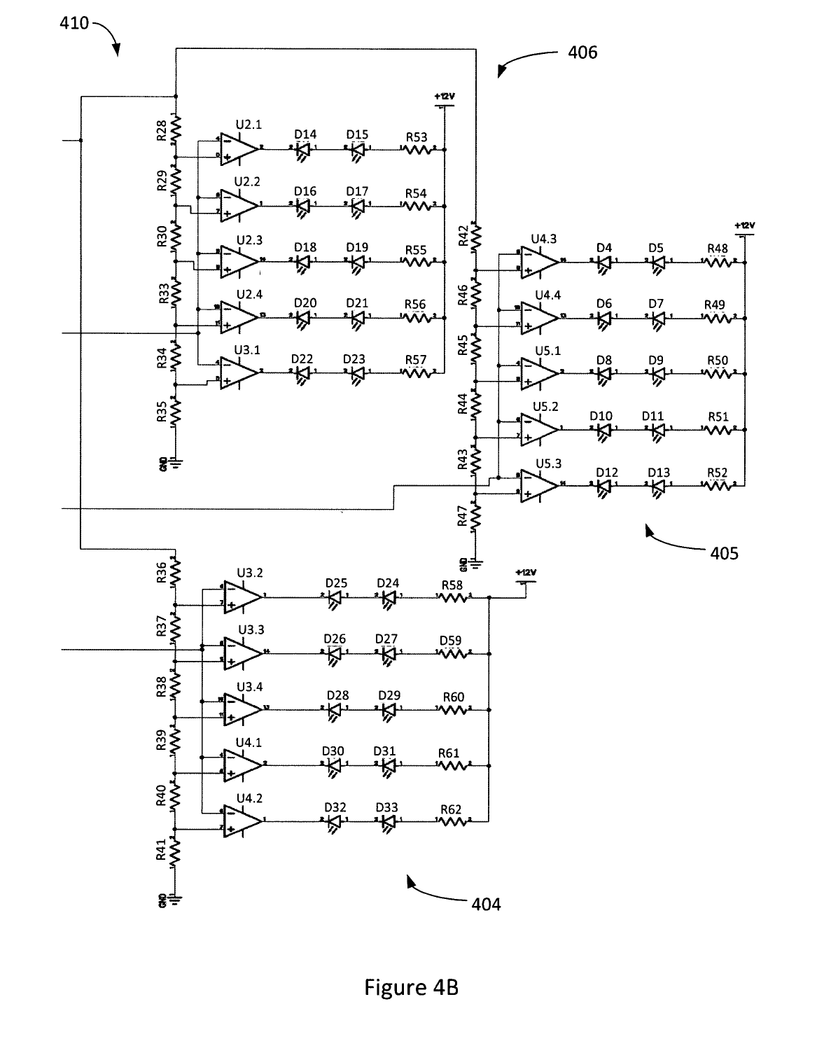

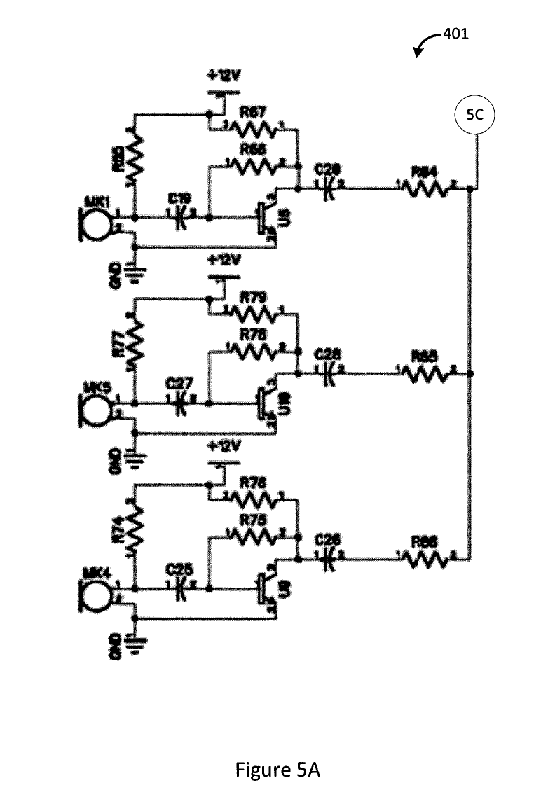

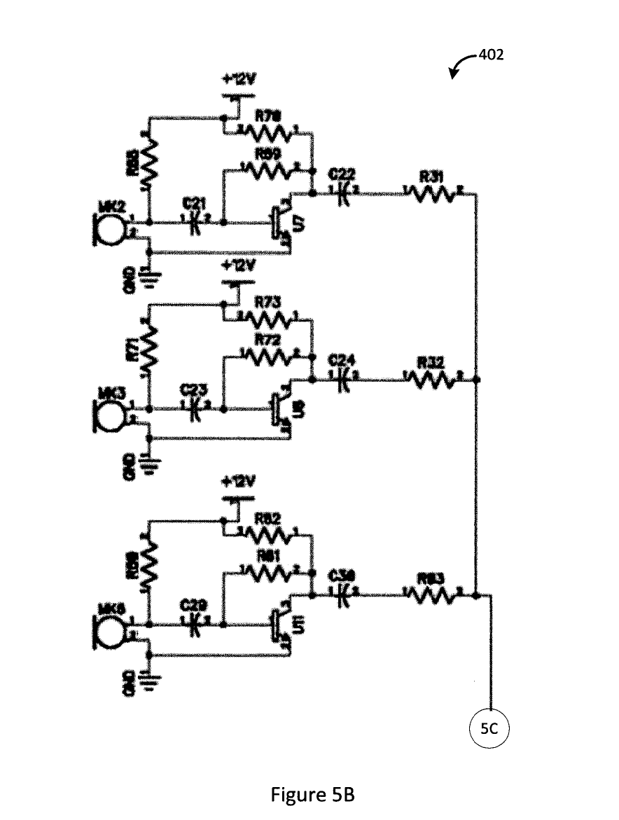

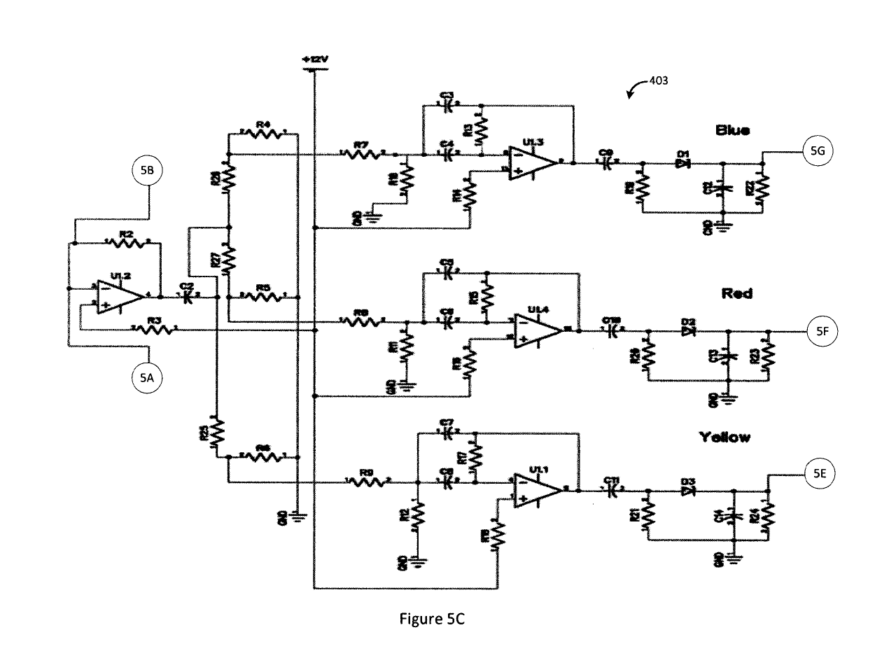

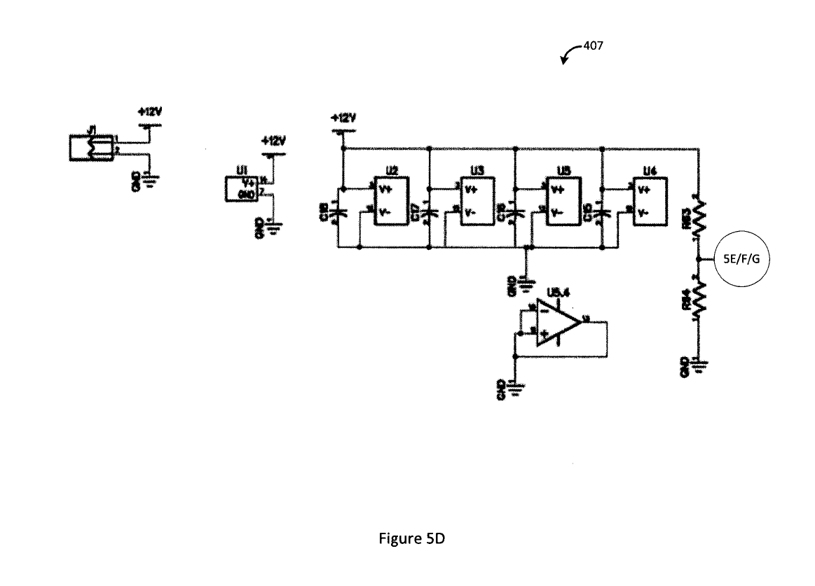

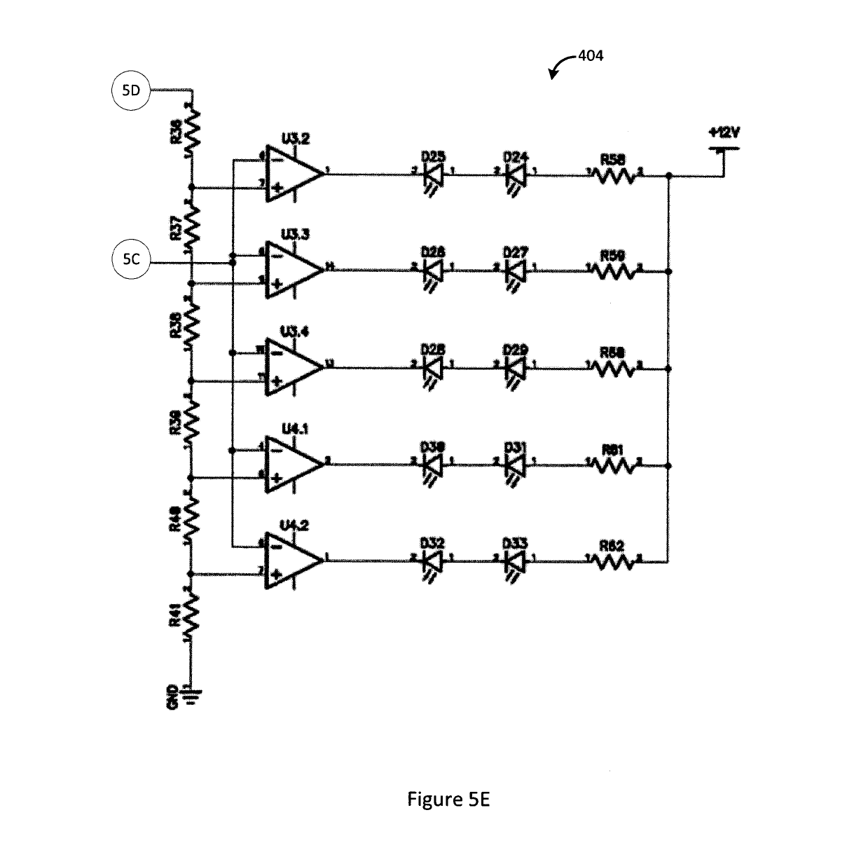

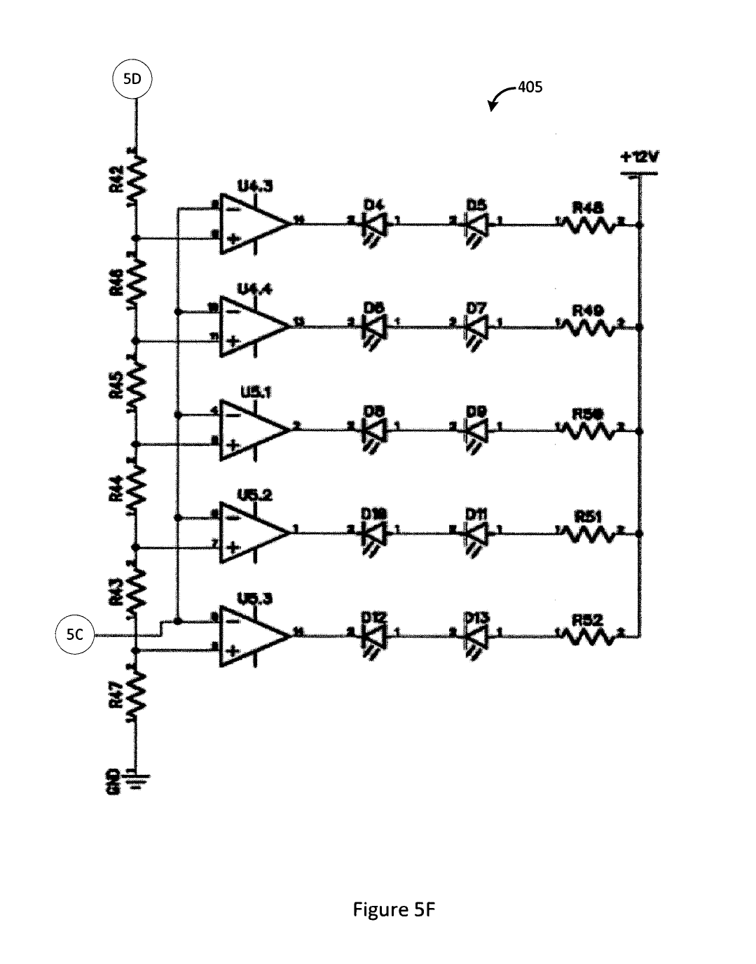

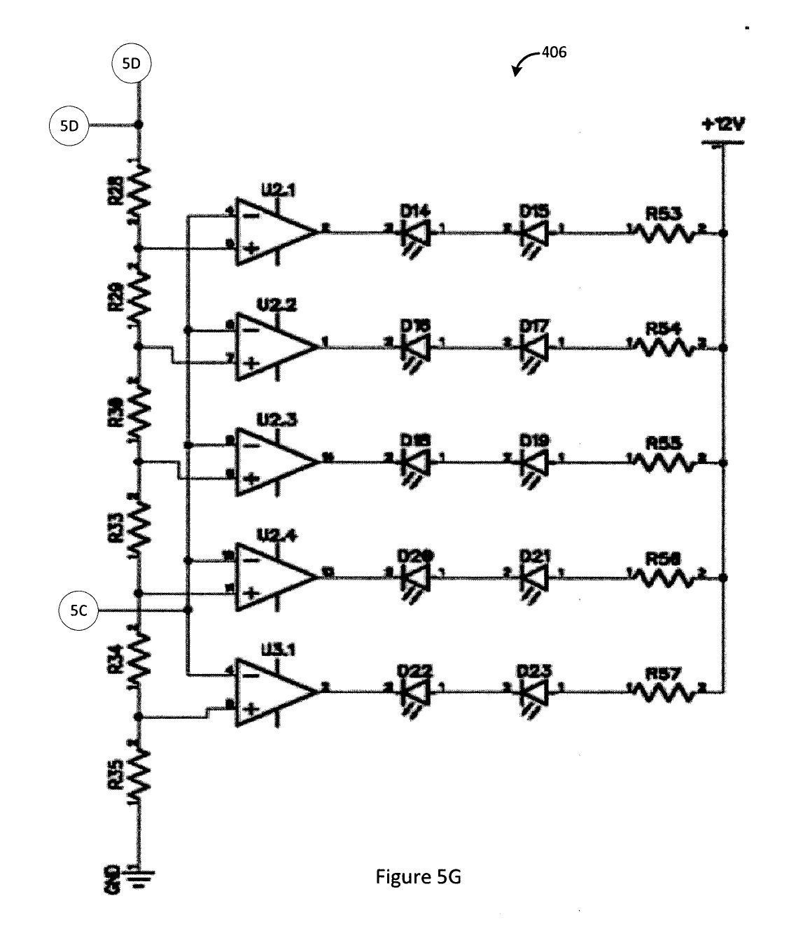

FIGS. 2A and 2B illustrate one embodiment of a transparent plastic overlay pickguard 200 configured for use on a Fender® Stratocaster® electric guitar. The printed circuit board 210 and electronic circuit components are visible through the transparent overlay 200. Each of the LEDs are indicated on FIGS. 2A and 2B, for example, by a Y for yellow, R for red and B for blue. The remaining electronic circuit components are better illustrated in the enlarged representations shown in FIGS. 3A-3D. FIG. 4 is a circuit diagram 120 for one analog embodiment of the color organ electronics as implemented on the printed circuit board 110, NS FIGS. 5A-5G are enlarged representations of portions of the circuit shown in FIG. 4. For this embodiment, a complete listing of the devices, their values, and their names, for the exemplary circuit 210 is included in the Appendix below.

The color organ circuit implementation provides a display of discretely-colored LEDs on the circuit board which respond to the frequency and/or amplitude of the notes being played on the instrument by the user. The LEDs are organized into multiple channels, with each channel responding to certain ranges of pitch (frequency) of the notes being played on the instrument, and driving LEDs of certain colors. A minimum of two separate channels is provided. In the illustrated embodiment, three channels are provided, wherein the first channel lights yellow LEDs for high frequency sounds, the second channel lights blue LEDs for middle frequency sounds, and the third channel lights red LEDs for low frequency sounds. The intensity of the LEDs can be correlated to the amplitude.

Referring to FIG. 4, the condensers MK1-MK6 are coupled to the pickups of the electric guitar to receive and process input signals in circuit portions 401 and 402, which are enlarged in FIGS. 5A and 5B, respectively. The input signals are provided to the main processing circuit portion 403, which is enlarged in FIG. 5C. The bottom portion of circuit 403 drives yellow LEDs in circuit portion 404, which is enlarged in FIG. 5D. The middle portion of circuit 403 drives red LEDs in circuit portion 405, which is enlarged in FIG. 5E. The top portion of circuit 403 drives blue LEDs in circuit portion 406, which is enlarged in FIG. 5F. Circuit portion 407 distributes power to the LED circuit portions, and is enlarged in FIG. 5G.

The circuit and components requires power and an input signal. The color organ pickguard can be powered by a 9-volt battery, which is preferably located separate from the pickguard due to the size of the battery. No external power other than the 9-volt battery is required. A holder for the battery and a connection from the battery to the color organ circuit is also provided. As an example, the battery can be enclosed in a fabric pouch and connected to the pickguard by a wire pigtail which conducts the current from battery to the electronic circuitry.

The input signal can be provided in one of two ways: (1) a direct electrical signal by wire leads from the instrument's transducer (pickup) in the case of an electric instrument intended for amplification and fitted with one or more pickups, such as an electric guitar; or (2) a self-contained or remote microphone(s) which converts the mechanical vibrations of the plucked strings into an electrical signal.

An alternative color organ circuit configuration could be implemented with digital circuitry using RGB multicolor LEDs. In such an embodiment, each LED could be individually addressed. The LEDs can be organized into multiple channels, where each channel is programmed to display a different color. The intensity of the LEDs may be correlated to the amplitude of the vibrating strings. A memory can be included with a number of different programs for how to illuminate different groups/channels/colors of the LEDs. Further, a programming interface may be provided, for example, through a standard USB interface.

4. Electric Instrument

In the case of an amplified electric instrument, such as a solid-body or semi-hollow electric guitar, mandolin, bass, etc., the plan view of the pick guard will either replicate the exact silhouette of the instrument's original pick guard, or it may have a different design. In either case, the color organ pickguard is intended as either a replacement or an overlay for the original pickguard.

In the majority of cases, the color organ pickguard will be an overlay, which may be attached by double-sided adhesive foam tape over the existing pick guard. In a minority of cases, the original pickguard (if any) is removed and any components attached to it are transferred to the color organ pickguard. This can be easily accomplished with a minimum of tools by the musician/hobbyist or by a luthier/technician, e.g., a small screwdriver or two and a small wrench.

For ease of installation, the color organ pickguard can be attached in two ways: (1) in the same manner as the original pickguard, the original pickguard is used as a pattern to locate holes to be drilled in the new color organ pickguard, and the original pickguard screws are used to attach the new color organ pickguard to the body of the instrument; or (2) the color organ pickguard can be attached to the surface of the instrument's body or the original pickguard using double-sided pressure-sensitive adhesive tape or hook and loop fasteners.

The 9V battery used for power is contained in a fabric pouch or rigid plastic container with a pigtail connection from the color organ pickguard which is long enough for the pouch or container to be either: (i) fastened to the back of the instrument by double-sided pressure-sensitive adhesive tape or hook and loop fasteners; (ii) attached to the strap of the instrument; (iii) carried in the player's pocket; or (iv) attached to the player's belt.

The input signal for the electronic circuit is provided through a second pigtail connection which is connected to the circuit board on the color organ pickguard on one end and fitted with leads and alligator clips at the opposite end. The alligator clips are clipped to the leads from the instrument pickup or transducer.

5. Acoustic Instrument

In the case of an acoustic instrument, such as an acoustic guitar or bass with a flat-top configuration, the plan view of the color organ pickguard is a shape which complements the design of the instrument's top. The shape can replicate the silhouette of the original pickguard's or be of a larger surface area and generic shape, in order to maximize the display area.

The original pickguard is removed, or if thin enough (i.e., single ply), it is left in place. The mounting options are identical to those used in the case of an amplified instrument, and in addition, magnets may be used to secure the color organ pickguard in place on the top surface of the acoustic instrument. The color organ pickguard can be installed as a replacement or an overlay. In either case, installation on most acoustic instruments requires no tools.

Power is provided in the same manner as for an electric instrument.

The input signal is provided by a piezo transducer ribbon installed under the bridge, then connected to a pigtail, which in turn is connected to the circuit of the color organ pickguard, or alternatively, to a miniature microphone(s) which could be self-contained on the pickguard, or which could be secured to the inside of the body of the guitar by double-faced foam tape or a hook and loop fastener.

It should be apparent from the foregoing that there are a number of ways to implement the principles described herein, and thus, the description is intended to cover various modifications and similar arrangements as would be apparent to those skilled in the art. Therefore, the scope of the appended claims should be accorded the broadest interpretation so as to encompass all such modifications and similar arrangements.

1. A color organ overlay circuit for mounting on a stringed musical instrument, comprising:
a printed circuit board formed with a color organ circuit, the color organ circuit having a plurality of surface mount devices including a plurality of light emitting diodes, the color organ circuit having at least two channels each associated with a different range of frequency signals generated by playing the stringed musical instrument, each channel driving a different colored group of light emitting diodes;
a thin laminate transparent or translucent layer formed over the printed circuit board;
a power source coupled to the printed circuit board;
a transducer coupled to the stringed musical instrument and the color organ circuit for converting sounds generated by playing the stringed musical instrument into frequency signals and amplitude signals; and
a connection apparatus for attaching the printed circuit board and thin laminate layer to the stringed musical instrument.

2. The color organ overlay circuit of claim 1, the color organ circuit further comprising at least one additional channel associated with a range of amplitudes generated by playing the stringed musical instrument.

3. A pickguard for a stringed instrument, comprising:
a circuit board having printed circuit traces formed on a first side thereof, the circuit board coupled to a power source and to a transducer on the stringed instrument;
a plurality of circuit components integrated with the circuit board and printed circuit traces, wherein the circuit board, printed circuit traces and circuit components are configured to implement a color organ, and wherein the circuit components include a plurality of light emitting diodes organized into at least two channels, each channel responsive to a different frequency of sounds emitted by the stringed instrument through the transducer; and
a laminate layer formed over the circuit components on the first side of the circuit board.

4. The pickguard of claim 3, each channel further responsive to an amplitude of the sounds emitted by the stringed instrument through the transducer.

5. The pickguard of claim 3, wherein the circuit components are surface mount devices.

6. The pickguard of claim 5, wherein each of the light emitting diodes is able to generate multiple colors.

7. The pickguard of claim 6, wherein the light emitting diodes are RGB diodes.

8. The pickguard of claim 3, further comprising a memory coupled with the circuit board and storing at least one set of program instruction for driving the light emitting diodes.

9. The pickguard of claim 8, further comprising a programming interface coupled to the circuit board.

10. The pickguard of claim 9, wherein the programming interface is a USB interface.
